(19) United States
(12) Patent Application Publication
(10) Pub. No.: US 2024/0051788 A1
(43) Pub. Date: Feb. 15, 2024

(54) ELEVATOR, METHOD FOR OPERATING AN ELEVATOR IN AN EMERGENCY

(71) Applicant: Inventio AG, Hergiswil (CH)

(72) Inventors: Juri Anzini, Moghegno (CH); Mirko Pifferini, Minusio (CH); Valerio Villa, Colverde (IT)

(21) Appl. No.: 18/258,258

(22) PCT Filed: Dec. 23, 2021
(86) PCT No.: PCT/EP2021/087475

§ 371 Date: Jun. 19, 2023

(30) Foreign Application Priority Data
Dec. 24, 2020 (EP) 20217227.6

(51) Int. Cl. B66B 1/32; B66B 1/30; B66B 1/34; B66B 1/46

(52) U.S. Cl. CPC B66B 1/32; B66B 1/30; B66B 1/3461; B66B 1/462; B66B 2201/4676; B66B 2201/406

(57) ABSTRACT

An elevator has a safety control unit that distinguishes between a first input signal and a second input signal at an input for selecting an operating mode. The elevator has a main switch device with a switch, the main switch device being accessible from outside a shaft of the elevator. The main switch device and the safety control unit are connected, wherein the switch is switchable from a first state into a second state. The safety control unit operates in a first operating mode when the switch is in the first state, in a second operating mode when the switch is in the second state and the safety control unit detects the first input signal at the input, and in a third operating mode when the switch is switched to the second state and the safety control unit detects the second input signal at the input.

### FIELD

The invention relates to an elevator and to a method for the emergency operation of the elevator.

### BACKGROUND

In the case of elevators in the context of special operation, that is to say, in emergencies during commissioning, during acceptance or during testing and also during maintenance and in other operating modes of the elevator system deviating from normal operation, it is necessary for specialist personnel to control the elevator. For this purpose, an elevator with corresponding control elements for controlling the individual functions of the elevator is required.

The utility model DE 29615921 U1 discloses a device by means of which elevator passengers can be evacuated in an emergency. The device is intended for elevator systems without a machine room, in which the drive unit is arranged in the shaft. If the elevator car gets stuck in the elevator shaft, the brake is manually released and the elevator car is moved to the nearest floor. The brake is actuated by means of a Bowden cable from the floor. During the evacuation, in the de-energized state of the elevator system the elevator car is moved on the basis of the imbalance between the elevator car with load and the counterweight. Only one battery is provided for feeding a signaling device, which indicates that the elevator car is located on the evacuation floor.

A disadvantage of known elevators and of methods for the emergency operation of these elevators is that the evacuation is rigidly predefined by the device.

### SUMMARY

It is an object of the present invention to provide an elevator which avoids the disadvantages of the prior art and in particular to provide an elevator and a method for the emergency operation of the elevator, with which it is possible to choose between a plurality of operating modes.

The object is achieved by an elevator and by a method for the emergency operation of the elevator according to the following description.

According to the invention, the elevator comprises an elevator shaft, a car movable in an elevator shaft, a drive for moving the car, a brake which is preferably designed as a car brake, and a safety control unit. The safety control unit has an input for selecting an operating mode. The safety control unit is designed to distinguish between at least a first input signal and a second input signal at the input. The elevator further comprises a main switch device with a switch. The main switch device is accessible from outside the shaft. The main switch device and the safety control unit are electrically connected. The switch can be switched from at least one first state to a second state. The safety control unit is configured such that it operates in a first operating mode when the switch is switched to the first state. The safety control unit is configured such that it operates in a second operating mode when the switch is switched to the second state and the safety control unit detects the first input signal at the input. The safety control unit is configured to operate in a third operating mode when the switch is switched to the second state and the safety control unit detects the second input signal at the input.

It is advantageous that, by combining a switch with at least one first and a second state and a first and a second input signal, for example in the second state of the switch, two different operating modes can be executed as a function of the input signal. The first state of the switch can thus be assigned independently of the input signal, for example to a normal operation, in which the switch connects without interruption an energy supply from the building to the elevator. The second state of the switch can be assigned to an emergency operation of the elevator, wherein different operating modes of the elevator are called up in the second state on the basis of the detection of a first or second input signal. Thus, for example, in the second state of the switch, when the first input signal is detected, an operating mode of the elevator can be executed which enables a simple evacuation. This can be, for example, the normal state of the elevator with the switch in the second operating state. In other words, for example, the first signal can be a zero signal, i.e. correspond to a state in which there is no signal present at the input. It is thus made possible for an individual, by simply switching the switch, i.e. switching the switch from the first state to the second state, to be able to transfer the elevator into an operating mode, in which an evacuation in predetermined and restricted basic conditions is made possible.

For example, the second operating mode can allow evacuation without any additional drive energy. During such an evacuation, solely an imbalance between the car and the counterweight is used for the movement of the car.

By means of the second input signal, which is a positive voltage signal different from the zero signal, for example, the second operating mode can be brought about simply, i.e. without a further switch state being required for this purpose. This makes it possible to notify a service technician, for example via a mobile device of the elevator controller, that he is supervising the evacuation, i.e. is at the elevator system. After the presence of the technician has been determined, the elevator controller can apply the second signal to the input and thus bring about the third operating mode.

A main switch device can thus be provided with which an untrained individual with no identification can carry out a simple evacuation solely by flipping the switch, without there being a risk that due to an incorrect manipulation of the switch this individual gets into an evacuation operating mode, in which the evacuation requires knowledge that this individual does not have. An elevator is thus provided which enables in a simple and safe manner an evacuation by untrained personnel and at the same time an evacuation by a qualified individual. This ensures that the waiting time of potentially locked-in individuals is kept as short as possible.

In a preferred embodiment, the switch can also be switched to a third state. In the third state, the switch interrupts an energy supply to the elevator. The switch is preferably designed as a rotary switch.

The main switch device, as described above and in the following, makes it possible for the elevator to be switchable from outside the shaft from normal operation to evacuation operation and also to de-energized operation. It is thus possible for all essential operating modes to be easily selectable from a central location.

The design of the switch as a rotary switch proves advantageous, since a plurality of switching states can easily be implemented in a rotary switch.

In a preferred embodiment, the switch is designed such that the second state is an unstable state.

Such a switch makes it possible for the second state, which enables the evacuation of the elevator, to be activated only when an individual actively selects this state. Remaining in this state unintentionally is prevented by the switch tipping back into a state different from the second state. It can thus be ensured that it is not possible to operate the elevator in evacuation operation, that is to say in the second operating mode, without an individual being in direct proximity to the main switch device. This increases the safety of the elevator.

In a preferred embodiment, the main switch device can be opened. The switch can only be switched from one state to another when the main switch device is open. The main switch device is designed such that it can only be opened by an authorized individual.

The main switch device, as described above and below, makes it possible to ensure that in order to change the operating mode the main switch device must first be opened by an authorized individual before the operating mode can then be changed via the switch. In the closed state, the main switch device thus forms a type of mechanical lock, which makes it impossible to alter the operating mode.

In a preferred embodiment, the main switch device can be locked. When the main switch device is locked, the switch can no longer be switched.

In a preferred embodiment, the safety control unit is designed such that in the first operating mode the elevator can be operated in normal operation.

In a preferred embodiment, the safety control unit is configured such that in a second operating mode it can perform an automatic pulsed emergency brake opening (PEBO).

PEBO is known from the prior art, for example from JP2011195270A.

It is made possible in the second switch position of the switch for an automatic pulsed release of the brake to take place without the presence of a second input signal. As a result, the elevator car moves at a certain speed in a certain direction depending on the weight ratios in the elevator. The pulsed opening and closing of the brake ensures that the car is not accelerated excessively quickly even in the case of a large imbalance. With the automatic PEBO, the car is automatically locked in place by means of a brake once the next floor has been reached, so that a safe position is provided for evacuating any passengers that may be stuck in the car.

In this operating mode, an automatic stop of the evacuation when certain threshold values are reached in the elevator system can also be fixedly predefined. For example, the evacuation can be stopped when a certain speed of the car is reached. Furthermore, covering a certain distance can also lead to a stop of the evacuation. These termination parameters ensure that the evacuation can be carried out safely even without a trained technician being present and only under clearly defined framework conditions.

In a preferred embodiment, the safety control unit is configured in a third operating mode such that the car can be moved manually. The car is preferably moved via a mobile device of an authorized individual.

In this case, a mobile device of the authorized individual can be used in a first step to generate the second input signal. For this purpose, the mobile device can, for example, establish an NFC connection with the elevator controller and via the Internet and a server of the elevator system instruct the elevator controller to generate the second input signal. The mobile device thus enables the third operating mode to be selected in the second switching state of the switch. In this third operating mode, the car can then be easily moved by the authorized individual via a GUI on the mobile device. Here it is also possible to display the position of the car in the shaft on the mobile device, so that the authorized individual is informed at all times about the position of the elevator car without a view into the shaft being necessary. This makes it possible for the authorized individual to be in manual evacuation operation only after identification in the safety control unit. At the same time, an efficient, intuitive and comparatively safer evacuation of the elevator car is made possible.

In a preferred embodiment, the second input signal is applied to the input when the safety control unit detects the presence of an authorized individual in the vicinity of the elevator. Otherwise, the first input signal will be applied to the input.

In a preferred embodiment, the presence of an authorized individual is detected on the basis, at least in part, of a communication with a mobile device. The mobile device is configured to scan a unique identification of the elevator. The identification is preferably only accessible for scanning by the mobile device when the main switch device is open.

A kind of two-stage safety concept is thus implemented. An individual can only identify himself as authorized if he is first of all able to unlock the main switch device (for example with a key) and then scans the identification with a corresponding mobile device (with the corresponding software). In this case, therefore, both the mechanical opening of the main switch device and the digital reading-in of the identification are necessary. In one embodiment, the identification can be designed as a barcode or QR code which is attached to the inside of a flap of the main switch device. The safety of the evacuation operation of the elevator is thus further increased.

In a preferred embodiment, the main switch device further comprises a plug for connecting an emergency power supply to the elevator.

It is possible that in an emergency the energy supply of the building, which is connected to the elevator via the main switch device, fails. A main switch device, which, as described above and in the following, has a plug for connecting an emergency power supply to the elevator, makes it possible in such an emergency to temporarily replace the main energy supply of the building with a mobile energy supply, so that the elevator can be provided with the necessary energy for operating the emergency functions, i.e. in particular the evacuation functions. The installation of this plug in the main switch device has the advantage that for evacuation of the elevator the authorized individual can straightaway connect the emergency power supply to the elevator at the location where he must control the evacuation operation anyway. In this way, there is no time-consuming running back and forth. An emergency power supply can be, for example, a battery.

In a preferred embodiment, the safety control unit is fastened to the car. The connection between the main switch device and the safety control unit is preferably designed as a secure, preferably wired, connection.

A connection can be deemed safe which satisfies, for example, the standardized Safety Integrity Level 1 (SIL1), preferably SIL2 and particularly preferably SIL3 according to IEC 61508 and/or EN 81-20 and/or EN 81-50.

A main switch device, as described above and below, includes all components which must be accessible from outside, i.e. outside the shaft, during operation of the elevator. A safety control unit, which is electrically connected to this main switch device, therefore does not need to be accessible. The main switch device and the connection of the main switch device to the safety control unit thus make it possible for the safety control unit to be placed at a location at which it can perform the functions otherwise assigned to it in a particularly efficient manner. Since the safety control unit in a preferred embodiment also controls the brakes of the elevator, which are designed, for example, in the form of car brakes, and optionally also monitors and controls the safety functions of the cars and/or shaft doors, it can be advantageous for this safety control unit to be mounted on the car. Transmission-related delays of the signals from safety-related sensors to the safety control unit can thus be largely minimized, as a result of which the elevator becomes safer.

In a preferred embodiment, the input is configured to detect a third input signal. The safety control unit is configured to operate in a fourth operating mode when the switch is in the second state and the safety control unit detects the third input signal at the input. In the fourth operating mode, the safety control unit is configured to manually release an elevator brake. Preferably, the safety control unit is configured in the fourth operating mode to manually release the elevator brake via a command which it receives from a mobile device of an authorized individual.

A third input signal thus makes it possible to provide in the second state of the switch a fourth operating mode in addition to the second operating mode and the third operating mode. Three different states, i.e. three different operating modes, can thus be provided in one switch state on the basis of a digitally generated signal. It is thus made possible to divide the evacuation operation of the elevator into three phases, wherein for the second and third phases in each case further safety precautions can be taken for identifying the individual, so that it can be ensured that these further phases of the evacuation can only be selected by appropriately authorized and trained individuals. This ensures that the safety-critical evacuation functions can only be carried out by appropriately trained personnel. The need for a complex mechanical switch with several locks and locking options is thus replaced by a combination of a simple mechanical switch and a correspondingly designed safety control unit. This also prevents an individual from inadvertently generating evacuation commands in an incorrect state of a mechanical switch, which endangers the safety of the passengers potentially stuck in the car. A message can be displayed by means of a display on the individual's mobile device in each case before the execution of the required evacuation function, which message warns the individual and shows him the consequence of the pending evacuation function. The safety of the evacuation is thus further improved.

### DESCRIPTION OF THE DRAWINGS

FIG. 1: a schematic representation of an elevator,

FIG. 2: a schematic representation of a main switch device in an open state in a side view, and

FIG. 3: the main switch device in an open state in a front view.

### DETAILED DESCRIPTION

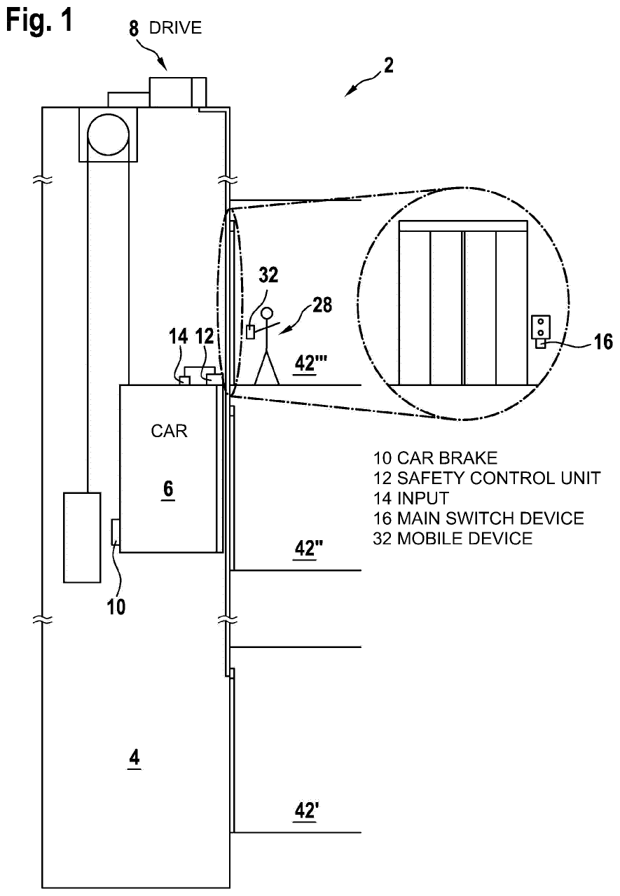

FIG. 1 shows an elevator 2. A part of the elevator 2 is shown in a front view, this being indicated by the dashed line.

The elevator 2 comprises a car 6 which can be moved along the shaft 4. The elevator car 6 is held by a support means, wherein the support means is, for example, a cable or a belt. At the other end, the support means is connected to a counterweight. The support means is driven by means of a drive 8.

The car 6 comprises a car door for opening and closing an access to the car 6. A safety control unit 12 is likewise mounted on the car. The safety control unit comprises an input 14. The elevator 2 further comprises a car brake 10 attached to the car 6.

In this exemplary embodiment, the elevator 2 comprises three floors 42′, 42″, 42″, wherein in FIG. 1 the car 6 is at the second, i.e. the middle, floor 42″ shortly before a stopping position. A individual 28 who is holding a mobile device 32 in his hand is located on the third floor 42″. On this floor 42″ a main switch device 16 is mounted in the vicinity of the shaft door below the call input device.

The position of the car 6 shown in the figure slightly above the floor 42″ is a position in which the car 6 has been unintentionally stopped in an emergency, for example a power failure. The individual 28 is a service technician who has come to the elevator 2 in order to move the car to a floor 42″ and there to evacuate the passengers who may be locked in the car 6.

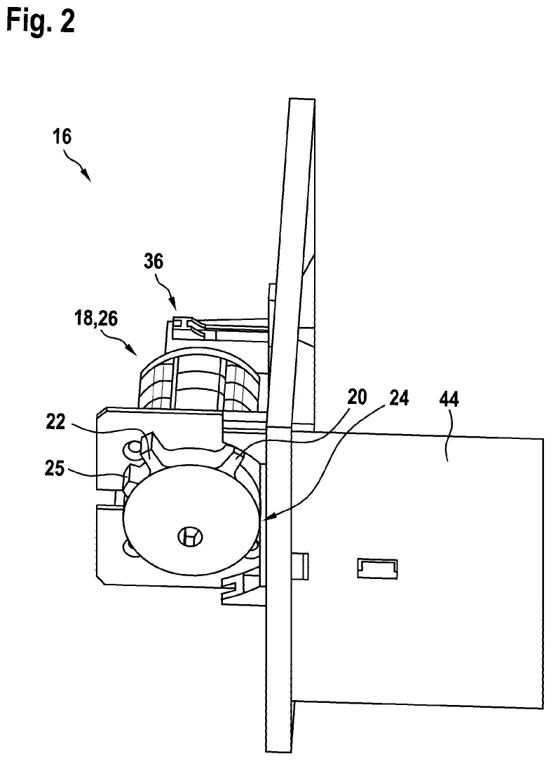

For this purpose, the individual 28 goes to the third floor 42″ where the main switch device 16 is. By opening the main switch device 16 and flipping the switch 18 (FIG. 2), which is mounted in the main switch device 16, and using the mobile device 32, the authorized individual 28 can move the elevator car 6 in the shaft 4. By means of the main switch device 16 and the mobile device 32, the individual 28 can do this without the need to access the safety control unit 12 on the car 6 and also without having to have visual contact with the car 6, since all the information relevant to the evacuation is displayed on the display of the mobile device 32.

FIG. 2 shows the main switch device 16, which comprises a switch 18, which in this embodiment is designed as a rotary switch 26. The main switch device 16 comprises a flap 44, which is shown in FIG. 2 in an open state. The main switch device 16 further comprises a plug 36, by means of which an external emergency power supply can be connected to the elevator 2 (not shown). FIG. 2 further shows that the rotary switch 26 can assume different states, wherein the states on the rotary wheel of the rotary switch are formed by nubs. The rotary wheel of the rotary switch can be rotated such that the state of the rotary switch changes. On the rotary wheel a first state 20 is shown. A second state 22 can also be seen. The rotary switch 26 is in the third state 24 in FIG. 2. In the exemplary embodiment shown in FIG. 2, the rotary switch 26 also has a fourth state 25.

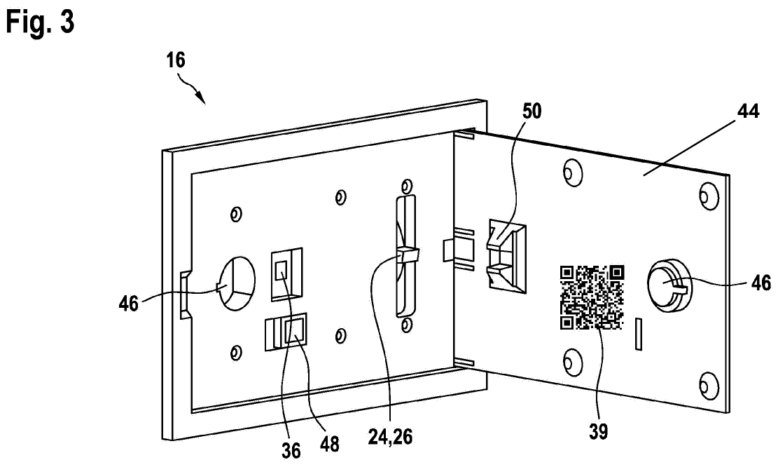

FIG. 3 shows the main switch device 16 in a front view. The main switch device 16 is again shown in an open state. The flap 44 can be seen in which a lock 46 is also mounted for securely locking the flap 44 in a closed state. The identification 39, which in this embodiment takes the form of a QR code, can also be seen on the flap 44. It is clear from FIG. 3 that the QR code 39 can only be scanned with the mobile device (not shown) when the flap 44 is in an open state. For this purpose, the lock 46 must first be unlocked. Furthermore, in FIG. 3 the nub 24 of the rotary switch 26 can be seen, the rotary switch being located precisely in this third state represented by the nub 24. A switch locking device 50 is formed on the flap 44, which when the flap 44 is closed engages the nub 24 and makes it impossible to change the state of the rotary switch 26. The plug 36 is also visible, which in FIG. 3 is in the same state as in FIG. 2, namely in a retracted state. The switch 26 can be moved out of the main switch device with a screwdriver, for example, so that an emergency power supply, for example a battery, can be conveniently attached to the plug 36. In FIG. 3, the flap locking device 48 can also be seen, which can be folded out by 90°, so that when the flap 44 is closed, the locking device protrudes into the flap 44 and, due to a lock being attached to the locking device 48, opening the flap 44 is no longer possible even when the lock 46 is open.

Finally, it should be noted that terms such as “comprising,” “including,” etc. do not preclude other elements or steps, and terms such as “a” or “an” do not preclude a plurality. Furthermore, it should be noted that features or steps which have been described with reference to one of the above embodiments may also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-13. (canceled)

14. An elevator comprising:
an elevator shaft;
a car movable in the elevator shaft;
a drive moving the car in the elevator shaft;
a brake attached to the car;
a safety control unit having an input for selecting from first, second and third operating modes of the elevator, the safety control unit adapted to distinguish between a first input signal at the input and a second input signal at the input;
a main switch device including a switch, the main switch device being accessible to an individual from outside the elevator shaft, wherein the main switch device is electrically connected to the safety control unit; and
wherein the switch is switchable between a first state and a second state, wherein the safety control unit selects the first operating mode when the switch is switched to the first state, selects the second operating mode when the switch is switched to the second state and the safety control unit detects the first input signal at the input, and selects the third operating mode when the switch is switched to the second state and the safety control unit detects the second input signal at the input.

15. The elevator according to claim 14 wherein the switch is a rotary switch.

16. The elevator according to claim 14 wherein the second state of the switch is an unstable state.

17. The elevator according to claim 14 wherein the switch is switchable to a third state in which the main switch device interrupts a power supply to the elevator.

18. The elevator according to claim 14 wherein the main switch device is operable between a closed state and an open state, wherein the switch is switchable between the first and second states only when the main switch device is in the open state, and wherein the main switch device is operable from the closed state to the open state only by an authorized individual.

19. The elevator according to claim 18 wherein the main switch device is lockable, and when the main switch device is locked, the switch cannot be switched.

20. The elevator according to claim 14 wherein the safety control unit, when the first operating mode is selected, operates the elevator in a normal operation.

21. The elevator according to claim 14 wherein the safety control unit, when the second operating mode is selected, operates the elevator to perform an automatic pulsed emergency brake opening.

22. The elevator according to claim 14 wherein the safety control unit, when the third operating mode is selected, operates the elevator such that the car can be moved manually by an authorized individual.

23. The elevator according to claim 22 wherein the authorized individual uses a mobile device to manually move the car.

24. The elevator according to claim 14 wherein the second input signal is applied to the input when the safety control unit detects a presence of an authorized individual in a vicinity of the elevator and the first input signal is applied to the input when the presence of the authorized individual is not detected.

25. The elevator according to claim 24 wherein safety control unit detects the presence of the authorized individual based at least in part on a communication with a mobile device configured to scan a unique identification on the elevator.

26. The elevator according to claim 25 wherein the unique identification is only accessible to be scanned by the mobile device when the main switching device is in an open state.

27. The elevator according to claim 14 wherein the main switching device includes a plug adapted to connect an emergency power supply to the elevator.

28. The elevator according to claim 14 wherein the safety control unit is mounted on the car and wherein the connection between the main switch device and the safety control unit is a secure, wired connection.

29. The elevator according to claim 14 wherein the safety control unit is adapted to detect a third input signal at the input, wherein the safety control unit selects a fourth operating mode when the switch is switched to the second state and the safety control unit detects the third input signal at the input, wherein the safety control unit, when the fourth operating mode is selected, operates the elevator to manually release an elevator brake by an authorized individual.

30. The elevator according to claim 29 wherein the authorized individual uses a mobile device to manually release the elevator brake.

31. A method for emergency operation of the elevator, the method comprising the steps of:
accessing a main switch device from outside an elevator shaft of the elevator, the main switch device having a switch and being electrically connected to a safety control unit of the elevator, wherein when the switch is switched to a first state the safety control unit selects a first operating mode to perform normal operation of the elevator;
switching the switch of the main switch device from the first state to a second state;
wherein when the switch is switched to the second state and the safety control unit detects a first input signal, the safety control unit selects a second operating mode to perform automatic pulsed emergency brake opening of a brake of the elevator; and
wherein when the switch is switched to the second state and the safety control unit detects a second input signal, the safety control unit selects a third operating mode to perform a manual movement of a car of the elevator.

32. The method according to claim 31 including the steps of:
scanning with a mobile device a unique identification on the main switch device; and
communicating the unique identification from the mobile device to the elevator to generate the second input signal to the safety control unit.
